(19) United States
(12) Patent Application Publication
(10) Pub. No.: US 2021/0154718 A1
(43) Pub. Date: May 27, 2021

(54) Portable Devices and Systems for Removing Flaws in Metallic Materials

(71) Applicant: THE DENTPAL, LLC, Creedmoor, NC (US)

(72) Inventor: John Ivan Sova, Creedmoor, NC (US)

(21) Appl. No.: 16/695,610

(22) Filed: Nov. 26, 2019

(51) Int. Cl. B21D 1/10; H01F 7/16; H04B 1/3827; B60S 5/00

(52) U.S. Cl. CPC B21D 1/10; B60S 5/00; H04B 1/3827; H01F 7/16

(57) ABSTRACT

Portable devices for manipulating metals are provided including a housing; an actuator positioned in the housing; and a battery positioned in the housing and coupled to the actuator, the battery providing a discharge current large enough to the actuator to cause a rod in contact with metal of target item to adhere to a surface of the target item and manipulate the metal of the target item where the rod contacts the metal of the target item.

### FIELD

Embodiments of the present inventive concept generally relate to correcting flaws in metallic materials and, more particularly, to portable devices for use in correcting flaws in metallic materials.

### BACKGROUND

A vehicle is a one of the biggest investments a consumer will make in a lifetime, second or third to a house or education. When a consumer buys a “new” vehicle, he or she may park that vehicle away from other vehicles in a parking lot to avoid getting the first blemish on the new vehicle. However, eventually it will happen and sometimes fixing this blemish will require removing an indentation in the body of the vehicle, i.e. a ding or a dent. Existing devices and systems for removing dings and dents in the body of a vehicle are generally large, heavy and cumbersome. For example, some existing devices may be about two hundred pounds with six or more feet of wire extending therefrom. Improved systems and devices for removing dings and dents are desirable.

### SUMMARY

Some embodiments of the present inventive concept provide a portable device for manipulating metals, the portable device including a housing; an actuator positioned in the housing; and a battery positioned in the housing and coupled to the actuator. The battery provides a discharge current large enough to the actuator to cause a rod in contact with metal of target item to adhere to a surface of the target item and manipulate the metal of the target item where the rod contacts the metal of the target item.

In further embodiments, the battery may include one or more lithium batteries and the actuator may be a solenoid.

In still further embodiments, the device may further include a coupling module configured to couple the actuator to a trigger associated with the rod.

In some embodiments, the device may further include a wireless transceiver. The coupling module may be one of wired and wireless. In embodiments where the coupling module is wireless, the wireless transceiver may be configured to facilitate communication between the actuator and the rod in contact with the metal target item.

In further embodiments, the device may be further configured to manipulate the metal of the target item by one of pulling out a dent in the target item where the rod contacts the metal of the target item and heating the metal of the target item where the rod contacts the metal of the target item to shrink the metal back into place.

In still further embodiments, the housing and contents thereof may weigh less than about ten pounds.

In some embodiments, the housing may further include one or more fastening elements. The fastening elements may be configured to attach the housing to a user in a wearable embodiment.

In further embodiments, the housing may be curved to accommodate a curve of a user's hip.

In still further embodiments, the device may further include an external port interface configured to receive external devices.

In some embodiments, the target item may be a vehicle.

Further embodiments of the present inventive concept provide a system for manipulating metals including a housing including an actuator and a battery coupled to the actuator; and a handheld module coupled to the actuator in the housing. The handheld module may include a trigger and a rod coupled to the trigger thereon, wherein activation of the trigger causes the battery to provide a discharge current large enough to the actuator to cause the rod in contact with metal of target item to adhere to a surface of the target item and manipulate the metal of the target item where the rod contacts the metal of the target item.

### BRIEF DESCRIPTION OF THE DRAWINGS

FIG. 1 is a diagram illustrating a system including a metal manipulation device in accordance with some embodiments of the present inventive concept.

FIG. 2A is a diagram of a rod/gun and ground connection for the system in accordance with some embodiments of the present inventive concept.

FIG. 2B is a diagram of the rod/gun for the system in accordance with some embodiments of the present inventive concept.

FIG. 2C is a diagram of the ground connection for the system in accordance with some embodiments of the present inventive concept.

FIG. 3 is a diagram of an exterior housing of a device in accordance with some embodiments of the present inventive concept.

FIGS. 4A and 4B are diagrams illustrating front and back covers, respectively, of a device in accordance with some embodiments of the present inventive concept.

FIG. 5 is a diagram illustrating a back cover of the device including a fastening mechanism configuring the device to be wearable in accordance with some embodiments of the present inventive concept.

FIG. 6 is a diagram illustrating the joining of front and back covers of the device in accordance with some embodiments of the present inventive concept.

FIG. 7 is a diagram of a printed circuit board including elements of the device in accordance with some embodiments of the present inventive concept.

### DETAILED DESCRIPTION

The inventive concept now will be described more fully hereinafter with reference to the accompanying drawings, in which illustrative embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. As used herein, the term “and/or” includes any and all combinations of one or more of the associated listed items.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As discussed above, a vehicle is a one of the biggest investments a consumer will make in a lifetime. When a consumer buys a “new” vehicle, he or she may park that vehicle away from other vehicles in a parking lot to avoid getting the first blemish on the new vehicle. However, eventually the vehicle will get its first blemish and sometimes fixing this blemish will require removing an indentation in the body of the vehicle, i.e. a ding or a dent. Existing devices and system for removing dings and dents in the body of a vehicle are large, heavy and cumbersome.

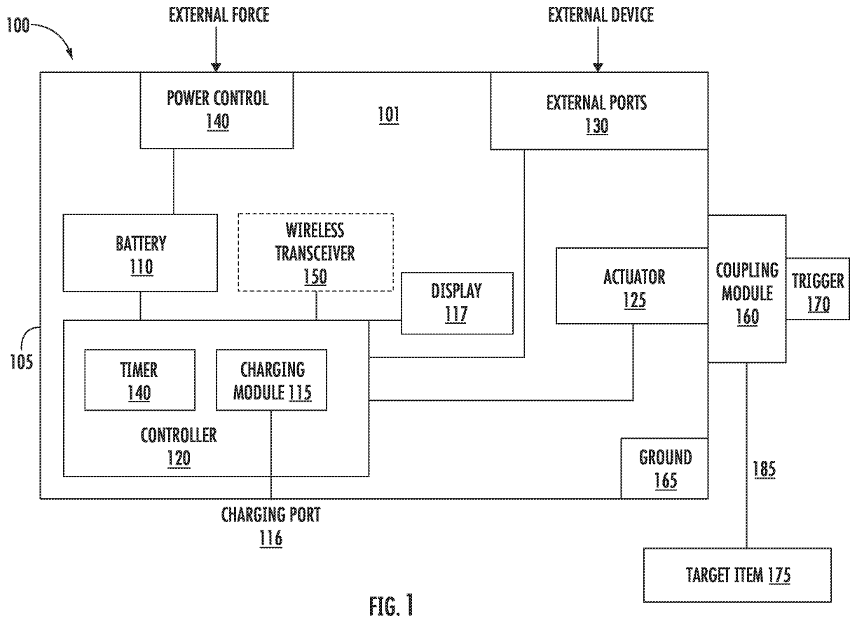

Accordingly, some embodiments of the present inventive concept provide a light weight, portable device that removes dents and dings in the body of a vehicle. In some embodiments, the portable device is a portable automotive collision repair tool for use by both professionals and non-professionals alike. The portable form-factor of devices in accordance with embodiments of the present inventive concept, which is a fraction of the weight and size of conventional devices, provides an advantage. For example, the portability and relatively small size of devices discussed herein allow for rapid, relatively easy action/movement, reduction of cost and time associated with body repair and the like. In some embodiments, the portable device discussed herein may be handheld or “wearable” and may respond to voice commands and have wireless properties as will be discussed further with respect to FIGS. 1 to 7.

As used herein, the term “portable” refers to the ability to be easily carried or moved, especially due to being a lighter and smaller version than usual. Thus, although conventional devices may be capable of being put in a vehicle or on a dolly and transported to a location of a vehicle in need of repair, this would not be considered portable in accordance with embodiments discussed herein. Rather, portable implies a relatively small, light-weight device capable of performing similar functions to a larger device. Similarly, as used herein, the term “wearable” refers to a mechanism associated with the device discussed herein that allows the device to be affixed/clipped to the user such that user does not have to hold the device in their hands. The advantage of wearable embodiments is the ability to use both hands while actually attending to the damage to the vehicle. However, even when the device is placed on a flat surface so that both hands of the user would be free, wearable embodiments would allow the user to move around the space without relocating the device that was placed on the flat surface.

Referring now to FIG. 1, a basic block diagram of a system for manipulating metals in accordance with some embodiments of the present inventive concept will be discussed. It will be understood that the block diagram of FIG. 1 is provided for example only and that embodiments of the present inventive concept are not limited thereto. For example, blocks in the diagram may be combined into a single block or one block could be divided into two or more without departing from the scope of the present inventive concept.

As illustrated in FIG. 1, the system 100 including a device 101, a coupling mechanism 160 having a trigger 170 associated therewith and a target item 175 for repair, for example, a vehicle including one or more dents/dings in the body thereof. As illustrated, the device 101 for manipulating metals in accordance with embodiments discussed herein includes a housing 105, a battery 110, a charging module 115, a charging port 116, a display 117, a controller 120, an actuator 125, an external port interface 130, power control 140, a timer module 140, an optional (as indicated by the dotted lines in FIG. 1) wireless transceiver 150, a means for grounding 165 the device 101, a trigger 170 associated with the coupling module 160 and a rod/gun 185 of a handheld portion of the system. As will be discussed further below, the device 101 and the components associated therewith may cause the connecting rod 185, for example, a tungsten rod, to weld an electrode to a damaged portion of the target item, for example, a vehicle. In some embodiments, once the electrode is welded to the target item 175, metal on the target item 175 may be pulled to remove concave damage (a dent) from the target item 175 or heated to so that convex damage (a bubble) to the target device 175 may shrink. Once the damage to the target item 175 is repaired, the rod/gun 185 (handheld portion) may be twisted until the rod/gun 185 disengages from the target item 175. It will be understood that once the dent/bubble on the target item 175 is pulled out/shrunk, additional body work may be required to full repair the damage. This remaining damage may be repaired by any method known to those of skill in the art without departing from the scope of the present inventive concept.

The controller 120 may be provided by a printed circuit board (PCB) including various components that cause the device 101 to engage the actuator 125 and repair the dent/bubble in the target item 175. As illustrated, the controller 120 interfaces with all components of the device 101. In particular, the actuator 125, which may be provided by a solenoid in some embodiments, is coupled to the trigger 170 through the coupling module 160. In some embodiments, the coupling module 160 may be a physical wire connection connecting the physical device 101 with the trigger and rod/gun 185. In further embodiments, the coupling module may be a wireless connection between the physical device 101 and the trigger 170 and rod/gun. These embodiments utilize the wireless transceiver 150 in the device 101 and a wireless element of the handheld portion of the device.

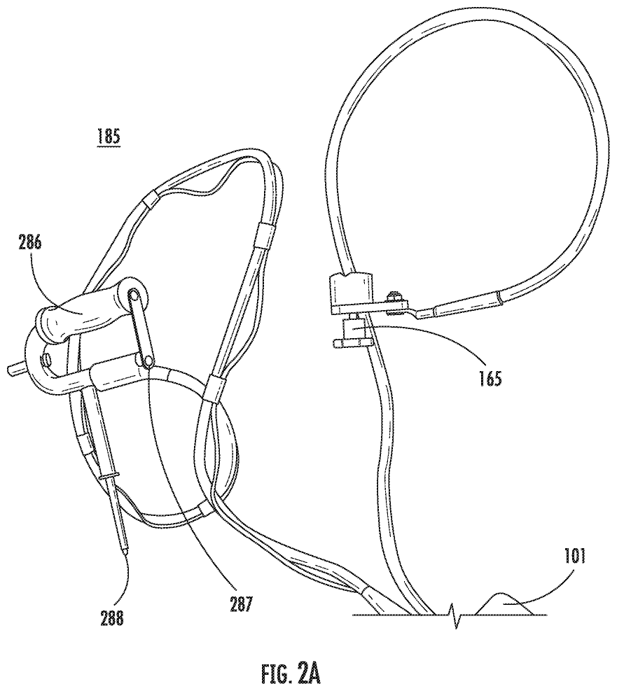

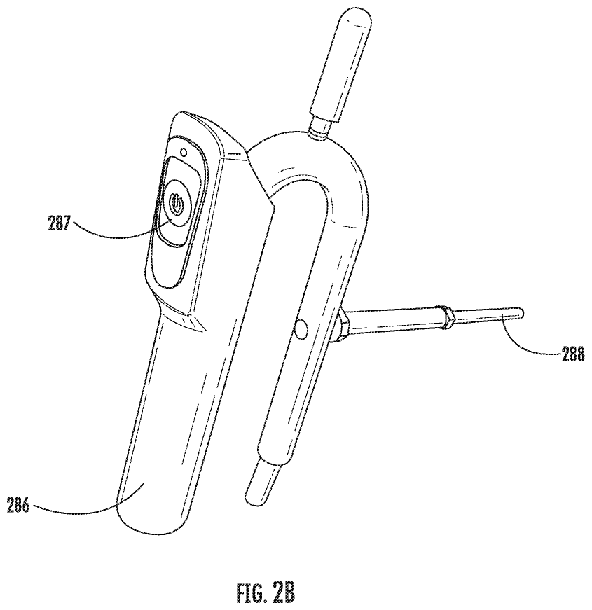

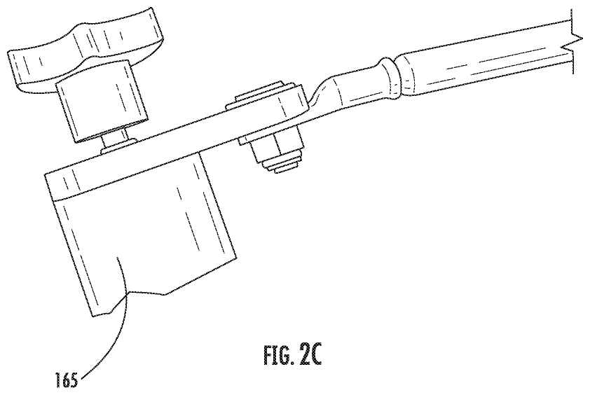

FIG. 2A illustrates an image of a handheld (rod/gun) 185 module (handheld module) and a ground module 165 in accordance with some embodiments. In these embodiments, the rod/gun 185 and the ground 165 modules are coupled to the device 101 using wires in FIG. 2A. However, as discussed above, in some embodiments the rod/gun 185 may have a wireless connection to the device 101. In these embodiments, a wireless transceiver will be positioned on the rod/gun 185. As further illustrated in FIG. 2A, the rod/gun 185 has a handle portion 286 that allows a user to grip the rod/gun 185, a trigger or button 170/287 that allows the user to activate the rod, and a tip 288. The tip 288 is the portion of the gun 185 that is touched to the metal shell of the target item 175 and adhered thereto responsive to the trigger/actuator. The tip 288 adheres to the metal shell of the target item 175 and is used to shrink or pull the metal back to the correct form. FIG. 2B is a diagram illustrating some embodiments of the handle/gun portion. As illustrated in FIG. 2B, a button is provided on the handle 286 which is used to maneuver and position the tip 288 into position on the target item. Further, FIG. 2C is a picture illustrating the ground module 165.

The timer 140 determines how long power is provided to the tip 288, which may depend on the material being adhered to as well as the extent of the damage to the target item. The value of the timer may be a user-selected time of action, which creates a one-shot activation of the welding action. In some embodiments, the timer 140 may provide a predetermined number of positions. The timer module 140 of the controller 120 controls a relay for momentary, one-shot activation.

In some embodiments, an additional material may be added to the surface of the target item 175 and used to increase the strength of the weld. In some embodiments, wave rod may be used to provide the additional material, however, embodiments of the present inventive concept are not limited thereto.

Referring again to FIG. 1, as further illustrated, the device 101 includes a battery 110, which allows the device to be used without being plugged into a wall. The battery 110 must be strong enough to provide power to the rod 185 so that it adheres to the surface of the target item 175. Some embodiments of the present inventive concept use lithium batteries and capacitors to provide a high-discharge current such that the tip (288, FIG. 2A) can be welded or adhered to a surface of the target item 175 to enable repairs. In some embodiments, this current may be from about 400 amp to about 800 amp. By using high-discharge and capacity lithium batteries and supercapacitors as a power source, devices 101 in accordance with embodiments discussed herein provide a device where there is no line-level power/alternating current (AC) conversion. Thus, there is no leakage current from the device, reducing the shock risk and hazard in the arcing/welding process.

In some embodiments, the device 101 includes three 6000 milliamp (mA) lithium polymer batteries that equal a total of 18,000 mA of current. In other embodiments, the battery may be a single 21,000 mA lithium battery. It will be understood that embodiments of the present inventive concept are not limited to this specific example, other form factors may be used without departing from the scope of the present inventive concept. As further illustrated in FIG. 1, the controller 120 (PCB) includes a charging module that may be used to maintain charge in the battery 110. In some embodiments, the charging module 115 ensures that each lithium battery cell is charged and utilized uniformly to increase longevity and efficiency of the batteries. However, it will be understood that the batteries do not have to be lithium batteries. In some embodiments, the device 101 may be charged using a charging port 116. The battery charge and health as well as other parameters may be shown on a display 117 on an exterior of the device.

As further illustrated in FIG. 1, the device further includes a power control module 140. This allows a user to turn the device 101 on or off. In some embodiments, the power control module 140 may be activated by a push button or toggle switch, however, embodiments of the present inventive concept are not limited thereto.

External devices, such as portable electronic devices, external storage drives, and the like, may be plugged into the device 101 using the external ports interface 130. In some embodiments, the external ports may be universal serial bus (USB) ports, however, other types of connectors may also be provided. The USB port may be used to plug in or charge a portable electric device as well as implement an application stored on the portable electronic device.

As discussed above, some embodiments of the present inventive concept include a wireless transceiver 150 that allows the device 101 to communicate wirelessly with the rod 185 that attaches to the target item. The wireless transceiver may be Bluetooth, WiFi or any applicable wireless communication protocol without departing from the scope of the present inventive concept. The wireless transceiver 150 may also be used to for wireless monitoring via a portable electronic device or application.

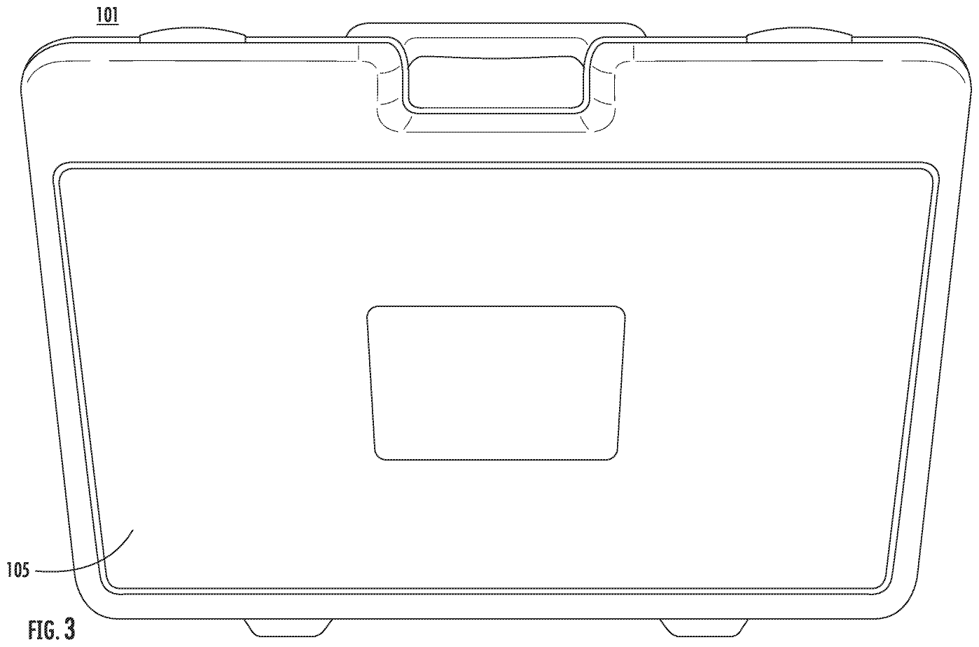

Referring now to FIGS. 3 through 7, the examples of an exterior of the device 101 in accordance with some embodiments of the present inventive concept will be discussed. As illustrated in FIG. 3, the components discussed above with respect to FIGS. 1 and 2A-C may be provided in a housing 105. The housing may be made of any suitable material, for example, plastic. In some embodiments, the housing has a length of about 8 inches, a width of about 8 inches and a depth of about 4.5 inches. In some embodiments, the device 101 has a weight of no greater than nine pounds, which allows the device 101 to be portable. It will be understood that these specific weights and dimensions are provided as examples only and do not limit embodiments of the present inventive concept thereto.

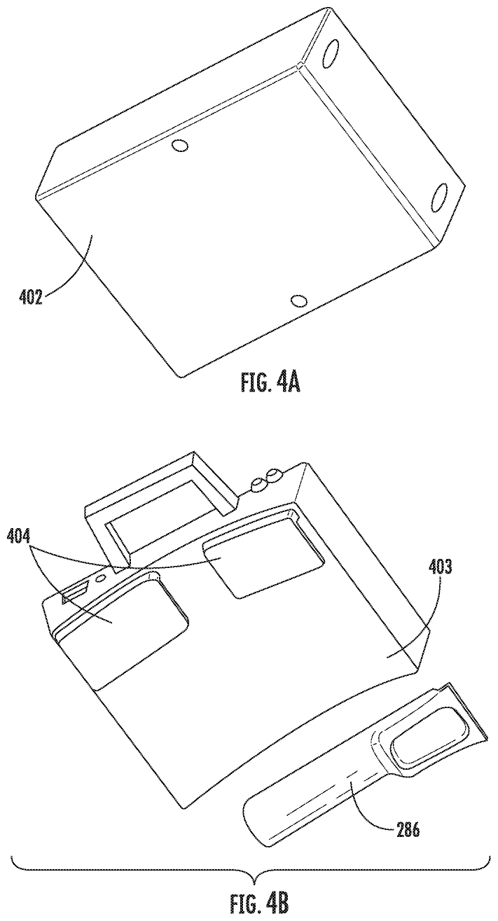

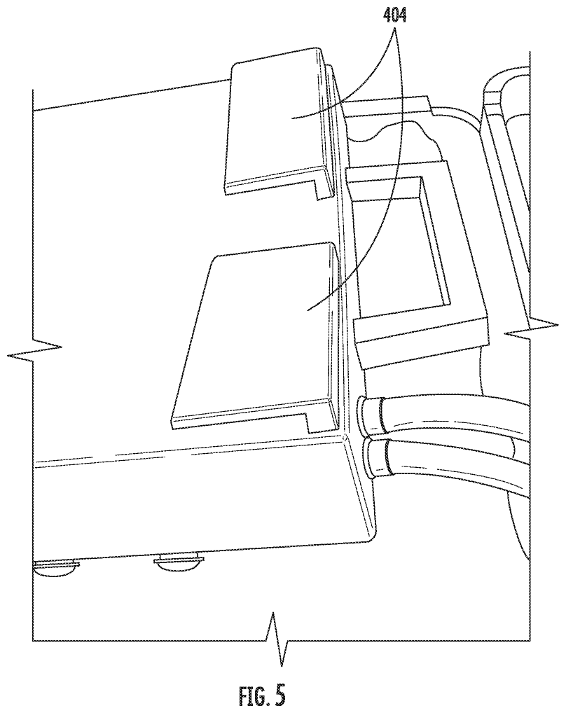

FIGS. 4A and 4B illustrate diagrams of front and back covers of the housing 105. FIG. 4A is a diagram of an embodiment of a front cover 4A of the device. As illustrated, the front cover 402 may include the trademark for the device, in this case “The Dentpal™.” However, embodiments may not include trademarks thereon. The back cover 403 of the device 101 is illustrated in FIG. 4B. As illustrated, the back cover 403 may include fastening elements 404 that allow the device 101 to be clipped to a belt or a waist band of a user's pants. In embodiments illustrated in FIG. 4B, the back cover 403 is curved to accommodate the curve of a user's hip to facilitate a more comfortable fit. The fastening elements 404 are also illustrated in FIG. 5. It will be understood that embodiments of the present inventive concept are not limited to those illustrated in FIGS. 4A and 4B.

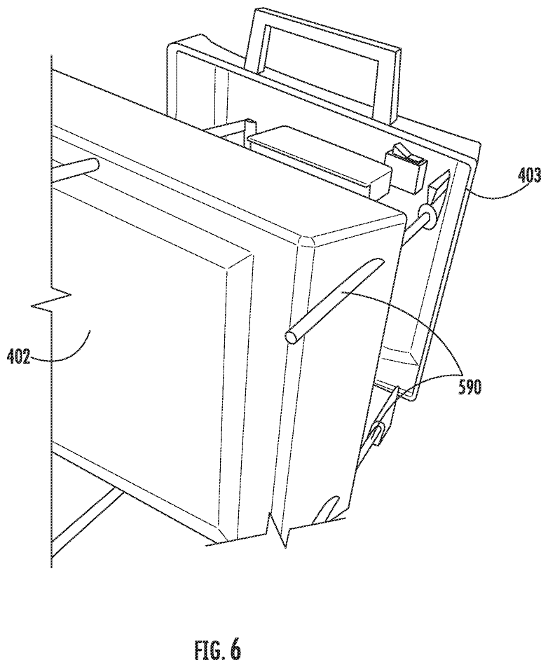

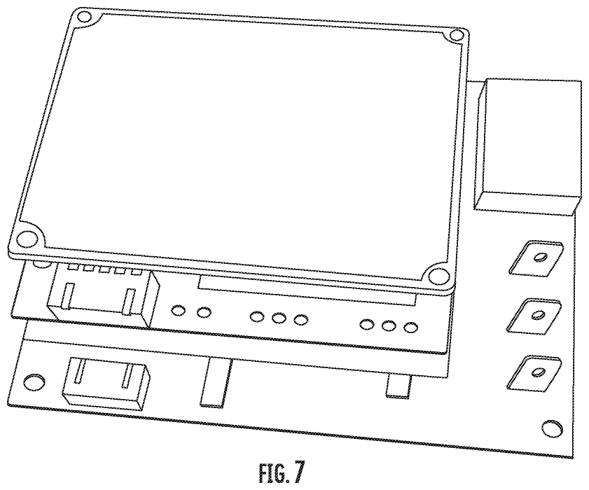

Referring now to FIG. 6, the front 402 and back 403 covers of the device 101 may be joined using fastening rods 590, such as pins, rods, screw of the like. Any fastening method may be used without departing from the scope of the present inventive concept. In embodiments illustrated in FIG. 6, the front 402 and back 403 covers are made to include holes to receive the fastening rods 590. However, clamps may be used to hold the covers together with providing hold in the actual housing. Elements discussed above with respect to FIGS. 1 and 2A-C may be providing in the housing 105 between front 402 and back 403 covers. An example of the PCBs including these components is provided in FIG. 7.

Although of the present inventive concept are discussed herein specifically with respect to the target item 175 being a vehicle, it will be understood that embodiments are not limited to this configuration. Systems and devices discussed herein may be used to remove indentations (dings and dents) in any item that lends itself to dings and dents, for example, metal garage doors, children's riding toys and the like. In other words, devices and systems discussed herein are not limited to automotive applications. Numerous industries and trades can benefit from a lightweight, portable device used to manipulate metals, these industries may include, for example, welding; manufacturing (either as an assembly, modification, or repair operation); heating and air conditioning; plumbing; arts and crafts and the like.

As discussed above, embodiments of the present inventive concept provide a portable, lightweight device that facilities removal of blemishes by manipulating metal. In some embodiments, the device may be provided in a wearable form factor that weighs less than 9 pounds. Devices and systems discussed herein can operate in space-constricted environments where traditional power and ample space may not be available. The battery-powered nature of the device allows to device to be a portable repair tool such that repairs can be made nearly anywhere and in any location. For example, devices in accordance with some embodiments of the present inventive concept may be used for emergency repair or use for roadside collisions/accidents, potentially eliminating the need to tow a car or may be used home or on-the-road collision or dent repair.

In the drawings and specification, there have been disclosed exemplary embodiments of the inventive concept. However, many variations and modifications can be made to these embodiments without substantially departing from the principles of the present inventive concept. Accordingly, although specific terms are used, they are used in a generic and descriptive sense only and not for purposes of limitation, the scope of the inventive concept being defined by the following claims.

That which is claimed is:

1. A portable device for manipulating metals comprising:
a housing;
an actuator positioned in the housing; and
a battery positioned in the housing and coupled to the actuator, the battery providing a discharge current large enough to the actuator to cause a rod in contact with metal of target item to adhere to a surface of the target item and manipulate the metal of the target item where the rod contacts the metal of the target item.

2. The portable device of claim 1, wherein the battery comprises one or more lithium batteries and the actuator comprises a solenoid.

3. The portable device of claim 1, further comprising a coupling module configured to couple the actuator to a trigger associated with the rod.

4. The portable device of claim 3, further comprising a wireless transceiver,
wherein the coupling module is one of wired and wireless; and
wherein when the coupling module is wireless, the wireless transceiver is configured to facilitate communication between the actuator and the rod in contact with the metal target item.

5. The portable device of claim 1, wherein the device is further configured to manipulate the metal of the target item by one of pulling out a dent in the target item where the rod contacts the metal of the target item and heating the metal of the target item where the rod contacts the metal of the target item to shrink the metal back into place.

6. The portable device of claim 1, wherein the housing and contents thereof weigh less than about ten pounds.

7. The portable device of claim 6, wherein the housing further includes one or more fastening elements, the fastening elements configured to attach the housing to a user in a wearable embodiment.

8. The portable device of claim 7, wherein the housing is curved to accommodate a curve of a user's hip.

9. The portable device of claim 1, further comprising an external port interface configured to receive external devices.

10. The portable device of claim 1, wherein the target item is a vehicle.

11. A system for manipulating metals comprising:
a housing including an actuator and a battery coupled to the actuator; and
a handheld module coupled to the actuator in the housing, the handheld module including a trigger and a rod coupled to the trigger thereon , wherein activation of the trigger causes the battery to provide a discharge current large enough to the actuator to cause the rod in contact with metal of target item to adhere to a surface of the target item and manipulate the metal of the target item where the rod contacts the metal of the target item.

12. The system of claim 11, wherein the battery comprises one or more lithium batteries and the actuator comprises a solenoid.

13. The system of claim 11, further comprising a coupling module configured to couple the actuator in the housing to the trigger on the handheld module.

14. The system of claim 13, wherein the housing further includes a wireless transceiver therein,
wherein the coupling module is one of wired and wireless; and
wherein when the coupling module is wireless, the wireless transceiver is configured to facilitate communication between the actuator and the rod in contact with the metal target item responsive to the trigger.

15. The system of claim 11, wherein the system is further configured to manipulate the metal of the target item by one of pulling out a dent in the target item where the rod contacts the metal of the target item and heating the metal of the target item where the rod contacts the metal of the target item to shrink the metal back into place.

16. The system of claim 11, wherein the housing and contents thereof weigh less than about ten pounds.

17. The system of claim 16, wherein the housing further includes one or more fastening elements, the fastening elements configured to attach the housing to a user in a wearable embodiment.

18. The system of claim 17, wherein the housing is curved to accommodate a curve of a user's hip.

19. The system of claim 11, wherein the housing further includes an external port interface configured to receive external devices.

20. The system of claim 11, wherein the target item is a vehicle.
